(19) United States
(12) Patent Application Publication
(10) Pub. No.: US 2013/0180931 A1
(43) Pub. Date: Jul. 18, 2013

(54) SOLAR-ACTIVATED PHOTOCHEMICAL FLUID TREATMENT

(71) Applicant: Mark D. Owen, Beaverton, OR (US)

(72) Inventor: Mark D. Owen, Beaverton, OR (US)

(73) Assignee: UVCLEANING SYSTEMS, INC., Beaverton, OR (US)

(21) Appl. No.: 13/822,586

(22) PCT Filed: Sep. 27, 2011
(86) PCT No.: PCT/US2011/053504

§ 371 Date: Mar. 12, 2013

Related U.S. Application Data
(60) Provisional application No. 61/386,920, filed on Sep. 27, 2010.

(51) Int. Cl. C02F 1/32; C02F 1/72

(52) U.S. Cl. CPC C02F 1/32; C02F 1/725
USPC 210/747.6; 210/170.05

(57) ABSTRACT

Disclosed herein are embodiments of a solar-activated photochemical fluid treatment system, some of which comprise an group of modules coupled together with attachment mechanisms, the group of modules comprising one or more floats. The modules comprise a porous substrate and a semiconductor photocatalyst coupled to the substrate. The group of interconnected modules can be configured to float at or near the surface of a body of fluid such that the fluid and sunlight can be in contact with the photocatalyst. The fluid treatment system can, responsive to solar radiation applied to the photocatalyst and to the fluid, induce photochemical modification of contaminants and living organisms in the fluid. Related methods are also disclosed.

### CROSS REFERENCE TO RELATED APPLICATION

This application claims priority to and the benefit of U.S. Provisional Patent Application No. 61/386,920, filed on Sep. 27, 2010, which is herein incorporated by reference in its entirety.

### TECHNICAL FIELD

This disclosure relates to the purification of a fluid, such as water, and more particularly to the removal, reduction and/or detoxification of contaminants in the fluid, such as organic chemicals, inorganic chemicals, heavy metals, microorganisms and others through sunlight-activated photochemical means.

### SUMMARY

Photochemical processes comprise a range of light-activated chemical reactions that have broad application in purification of fluids. A variety of these photochemical processes can be activated by sunlight. Light-activated photocatalytic oxidation is an advanced oxidation process that involves the creation of nonselective, strongly oxidizing hydroxyl radicals at the fluid-photocatalyst interface that mineralize (i.e., convert to carbon dioxide, water, and inert byproducts) a wide range of organic compounds in water or in the presence of water. The photocatalytic process also produces reduction sites that participate in reduction of inorganic ions as well as photoadsorption of toxic heavy metals. Still further, the photocatalytic process also produces “super oxygen” ions and other species that contribute to further fluid purification reactions. Semiconductor chalcogenides (particularly oxides and sulfides) namely TiO₂, ZnO, WO₃, CeO₂, Zr0₂, SnO₂, CdS, and ZnS, have been evaluated for photocatalytic effectiveness, with anatase titania (TiO₂) generally delivering the best photocatalytic performance with maximum quantum yields. Titania is known to have strong sorption affinities for heavy metals, including toxic metals such as lead, arsenic and mercury. Photoadsorption is one example of a photo-enhanced sorption process that can efficiently remove heavy metals dissolved in a fluid to stable sorption sites on the surface of a photoactivated semiconductor material. As yet another example of a photochemical process, illumination of a fluid such as water or air with light, especially with ultraviolet (UV) light, can directly induce breaking of chemical bonds through photolysis within some first organic compounds in the fluid, forming new compounds and thereby reducing the concentration of said first organic compounds. As still another example, illumination of a fluid such as water or air with light, especially UV light, of sufficient intensity can be used to disinfect the fluid photochemically by directly killing or sterilizing microorganisms therein. As yet another example, illumination of a fluid such as water or air with light of sufficient intensity can disinfect the fluid indirectly by photothermally heating the fluid and thereby killing microorganisms therein. A plurality of photochemical processes, such as selected from the group comprising photocatalytic oxidation, photocatalytic reduction, photolysis, photodisinfection, photoadsorption and photothermal disinfection, as well as other photo-activated processes, acting synergistically, can be used in the optimization of photochemical treatment systems.

One aspect of embodiments of the present disclosure is the enabling of multiple photochemical processes in a floating or buoyant solar-activated photochemical fluid treatment system. A further aspect of selected embodiments of the present disclosure is enhancing the performance of each photochemical process enabled in such a photochemical fluid treatment system, resulting in synergies among the processes. A further aspect of selected embodiments of the present disclosure is the use of a photocatalyst coated onto or otherwise adhered to a stationary substrate to affect photochemical processes for purifying a body of fluid exposed to direct or indirect sunlight. A further aspect of selected embodiments of the present disclosure is the use of solar-activated photochemical processes to remediate or purify environment bodies of fluid such as lakes, ponds, rivers, and pools containing fresh water as well as contaminated bodies of fluid such as pools containing treated or untreated waste water, industrial effluent and brackish water from subterranean hydraulic fracturing (“fracking”) operations.

Photochemical processes at photocatalyst surfaces involve the illumination of the semiconductor photocatalyst with photon energies at or above the band gap energy of the semiconductor in order to create the electron-hole pairs that effect photochemical reactions at or near the semiconductor surface. Solar radiation incident on the Earth's surface comprise a broad spectrum of wavelengths, including ultraviolet (UV), visible and infrared (IR) wavelengths. A number of semiconductor photocatalyst materials, including titania (TiO₂) in its anatase structure, have band gap energies that correspond to wavelengths of light present in this solar radiation incident on the Earth's surface, and photocatalytic processes at photocatalyst surfaces can therefore be activated by this solar radiation. Solar radiation in various wavelength bands can also contribute to the activation of other photochemical processes, including but not limited to direct photodisinfection of microorganisms in the fluid and indirect disinfection through photothermal heating of the fluid.

Photochemical purification processes, including photolysis, photodisinfection, photoadsorption and photocatalysis, can require delivery of light and contaminants to reaction sites. Maximizing available photocatalyst surface area can also be desirable for an improved photochemical fluid decontamination system. Suspensions of photocatalyst nanoparticles in a fluid can provide a high photocatalyst/fluid contact surface area. Nanoparticle suspensions can have, for example, surface area densities up to approximately 50 square meters per liter of treated fluid. However, suspended particles can be effectively stationary relative to the fluid, limiting fluid flow near the semiconductor-fluid interface and thereby limiting mass transport of contaminants to the surface. Additionally, a nanoparticle slurry system can require that the nanoparticles be introduced into the fluid prior to processing and then removed from the fluid after processing. An exemplary treatment system in accordance with an aspect of this disclosure improves on these nanoparticle slurry limitations by, for example, retaining the catalyst on its stationary substrate during use without requiring active management of the photocatalyst to preserve its effectiveness.

Some aspects of the present disclosure relate to an apparatus and method for fluid treatment that employs one or more photochemical mechanisms to provide efficient removal of multiple contaminants from the fluid. Exemplary embodiments can incorporate a photocatalyst on a fixed porous substrate within a housing that (1) is desirably itself porous to allow water to circulate through the porous substrate; (2) is desirably at least partially light transmissive or open, or both, to allow sunlight to penetrated the housing and illuminate the photocatalyst within the housing; and (3) desirably substantially maintains the shape, orientation and functionality of the photocatalyst within the housing during handling and use.

Further aspects of the present disclosure relate to a solar-activated photochemical fluid treatment system comprising a plurality of modules coupled together with one or more connectors comprising attachment mechanisms, the modules can comprise one or more floats, a porous substrate and a semiconductor photocatalyst coupled to the substrate. The substrate can be a fiber substrate. In some embodiments, the modules can further comprise a water permeable housing wherein the substrate is wholly or partially contained within the housing. The plural modules can be interconnected as a group or raft of modules. The group can be arrayed in a spaced array and can have equal spacing between the modules. Alternatively, the group can be irregularly spaced apart. One or more individual modules can be anchored to retain the group of modules at a desired location for liquid treatment. This disclosure also encompasses individual modules comprising one or more floats, a fiber substrate, optionally contained at least partially within a liquid permeable housing, and at least one semiconductor catalyst coupled to the fibers of the fiber substrate. Groups of such individual modules interconnected into a raft of plural modules are also encompassed by this disclosure. In addition, although desirable, not all of the modules in a group of modules need to float individually, as a common floatation structure can be used to cause the group to float. The common floatation structure can comprise one or more of the modules in the group of modules. The term float is to be broadly construed as mechanism that adds buoyancy to one or more modules that is sufficient to make the overall buoyancy of a group of modules greater than the liquid being treated. A group of interconnected modules can be configured to float at or near the surface of a body of fluid such that the fluid and sunlight can enter the housings and/or be in contact with the photocatalyst. The fluid treatment system can, responsive to solar radiation applied to the photocatalyst and to the fluid, induce photochemical modification of contaminants and living organisms in the fluid.

In this disclosure, it is to be understood that the terms “a”, “an” and “at least one” encompass one or more of the specified elements. That is, if two of a particular element are present, one of these elements is also present and thus “an” element is present. The phrase “and/or” means “and”, “or” and both “and” and “or”. Further, the term “coupled” generally means electrically, electromagnetically, and/or physically (e.g., mechanically or chemically) coupled or linked and does not exclude the presence of intermediate elements between the coupled or associated items absent specific contrary language. Unless specifically stated otherwise, processes and methods described herein can be performed in any order and in any combination, including with other processes and/or method acts not specifically described. The exemplary embodiments disclosed herein are only preferred examples of the invention and should not be taken as limiting the scope of the invention.

The foregoing and other features of the invention will become more apparent from the following detailed description, which proceeds with reference to the accompanying figures.

### BRIEF DESCRIPTION OF THE DRAWINGS

FIG. 1 is a side elevational view of an embodiment in accordance with the present disclosure.

FIG. 2 is a side elevational view of another embodiment of in accordance with the present disclosure.

FIG. 3 is a view of an embodiment of an enclosure containing fibrous material in accordance with the present disclosure.

FIG. 4 is a side elevational view of another embodiment in accordance with the present disclosure.

FIG. 5 is a perspective view of another embodiment in accordance with the present disclosure.

FIG. 6 is a view of an embodiment in accordance with the present disclosure, comprising a plurality of the embodiments of FIG. 5 linked together.

FIG. 7 is a side elevational view of another embodiment in accordance with the present disclosure.

FIG. 8 is a side elevational view of yet another embodiment in accordance with the present disclosure.

### DETAILED DESCRIPTION

In accordance with desirable embodiments, one or more photocatalysts can be coupled to, such as affixed to or bonded to, a fibrous substrate in a solar-activated photochemical fluid treatment system for the disinfection and purification of a fluid, such as water or air, such as for use in commercial and industrial applications. Applications include, but are not limited to, point-of-use markets, for cleanup of contaminated process outflow such as waste water and exhaust gases, and environmental remediation. Of course these are just examples and one skilled in the art will recognize a wide range of additional applications of the present disclosure, including, but not limited to, producing drinking water or process water and removing biological oxygen demand and total organic carbon from waste water and greywater. Transportable embodiments of the fluid treatment system can also be useful for remote applications such as passive remediation of surface waters over extended treatment periods without a requirement for monitoring or maintenance.

An effective and efficient solar-activated photochemical system for fluid disinfection and purification with photocatalytic functionality can utilize the delivery of sufficient solar illumination intensity to a photocatalyst to activate its photochemical performance, and the incorporation of sufficient photocatalyst to effectively absorb that light. Furthermore, the illuminated fibers with photocatalyst coupled thereto can be dispersed or distributed within at least a portion of the fluid being treated in order to purify and disinfect substantially all, or all, the fluid effectively. Still furthermore, contaminants in the fluid can be substantially, if not entirely, purified and disinfected at the surface of the photocatalyst, so that it can be desirable that the surface area of the photocatalyst is relatively large.

In some exemplary embodiments for disinfecting and purifying a fluid, the fluid to be treated can be presented to, or exposed to, an inert, semi-rigid, fibrous material that is at least partially transmissive to light, such as sunlight (i.e., the fibrous material allows at least a portion of sunlight incident upon it to pass into and/or through the fibrous material), and through which fluid can flow, and onto which one or more high-surface-area photocatalysts can be permanently bonded. The terms “sunlight”, “solar light”, “solar radiation”, “solar illumination” and the like are used interchangeably herein. The terms “transmissive to sunlight”, “sunlight transmissive”, and the like can be defined with respect to specific sunlight wavelengths, such as a spectrum of UV sunlight that is between 350 nm and 400 nm. A fibrous material is defined to be partially transmissive to sunlight if at least 30% of the sunlight in the 350 nm to 400 nm spectral range incident on the fibrous material penetrates to a depth of 1 cm into the fibrous material. The light transmissivity is affected not only by the material forming the fibers, but also by the packing density thereof. A material is defined to be light transmissive (e.g., a material for an overall enclosure, or individual fibers of a firbrous material) if at least 30% of the sunlight in the 350 nm to 400 nm incident on the material passes through the material. In this disclosure, the term substantially transmissive to sunlight means greater than 70% transmissive of sunlight in the 365 nm to 390 nm range and greater than 80% transmissive of sunlight in the 400 nm to 1000 nm range.

Embodiments of the photocatalyst material described in the present disclosure and the exemplary apparatuses and methods for its use in photochemical disinfection and purification of fluids can be further characterized by high mass transfer efficiency resulting from large photocatalyst surface area.

Some desirable embodiments can comprise a photocatalyst bonded to an at least partially sunlight transmissive substrate material to provide improved photocatalytic performance. The substrate material can be on at least partially light transmissive material, such as a thin fiber polymer or glass, that is etched, perforated, or otherwise provided with surface area enhancing features that can support a photocatalyst. The substrate material can desirably be fibrous and can comprise, for example, quartz, glass or another ceramic, or it can comprise a polymer or other plastic that can be readily formed into fibers. The photocatalyst can be selected, for example, from the semiconductor chalcogenides including TiO₂. Some embodiments employ titania (titanium dioxide, TiO₂) nanoparticle material for the photocatalyst, which can be in the form of a fibrous coating, because of its established effectiveness in photocatalytic degradation of organic materials, and quartz fiber for the substrate because titania bonds particularly well to quartz. Some embodiments further employ a specific surface area density of >500 m² per gram of photocatalyst.

One exemplary embodiment comprises a coating of TiO₂ on a loosely woven silica fiber substrate, prepared so that a majority (more than 50%) of the TiO₂ is in its anatase form and so that the specific surface area of the coating is approximately 1000 times the surface area of the fiber substrate, and the coating thickness is less than one micron. The coating can be continuous or discontinuous. Quartzel® is a commercially-available example of such a substrate with TiO₂ adhered thereto and is available from Saint-Gobain.

The fiber substrate can be prepared as a mass of fibers with random fiber orientation and spacing. The mass distribution of the photocatalyst can therefore be determined by the thickness of the photocatalyst coating, the diameter of the fibers comprising the substrate, and the density of the fiber mass. For example, with a 9 μm fiber diameter and a 0.5 μm coating thickness, and with approximately 100 m of this coated fiber per mL of volume, the specific photocatalyst area density can be greater than 2000 m²/L. The fiber mass in this example comprises approximately 1% of the volume it occupies, so that the fiber mass presents low impedance to fluid flow and therefore a low fluid pressure drop in flow across the fiber mass. The fiber-to-fiber spacing in this example varies from zero to more than 1 mm, with average spacing of approximately 0.5 mm, presenting a wide range of effective pore sizes and diverging pathways to fluid flowing through the fiber mass.

Furthermore, in one example, the fibrous material can comprise or consist of a quartz or other fiber substrate that is highly transmissive to sunlight over a wide range of wavelengths useful for creating electron-hole pairs in multiple photocatalyst systems. This transmissivity provides pathways through the substrate for sunlight to penetrate to the photocatalyst coating even in the presence of strong optical absorption by contaminants in the fluid being treated.

Photocatalyst coated onto, or otherwise coupled to, a fibrous substrate can be captured and contained, in whole or in part, in an enclosure, or housing, that is water-permeable in that the enclosure permits liquid flow into and through the enclosure and allows sunlight to pass into the enclosure to activate the photocatalyst. One exemplary enclosure material is a porous mesh made of a heat-sealable polymer or other plastic material. The term “porous” means that the enclosure can comprise sufficiently small pores or openings to mechanically contain the fiber substrate while having sufficiently large enough pores to allow the fluid to flow into and through the enclosure, and permit transmission of UV light to and through the photocatalyst coated fibers therein. The photocatalyst/fiber material can be inserted through a suitable opening into a partially formed enclosure of such mesh and then the opening can be sealed to capture the photocatalyst/fiber within the formed enclosure. Alternatively, the mesh material can be placed on either side of a photocatalyst/fiber mass and the mesh material on the opposing sides can then be heat sealed, welded or otherwise bonded (e.g., adhesively bonded) around the perimeter of the photocatalyst/fiber mass.

In some embodiments, this seal of the enclosure material around the photocatalyst/fiber mass can overlap the edges of the mass, capturing the mass so that it cannot mechanically collapse to fill less than a desired portion of the enclosure and thereby have reduced photochemical interactions with fluid passing through the mass.

Still furthermore, the enclosure material and construction methodology can be selected to create a photocatalyst/fiber filled or containing enclosure that has an overall density near or below the density of the fluid being treated, so that the photocatalyst/fiber containment enclosure tends to float at or near the surface of the fluid body being treated, increasing and/or maximizing the amount of UV solar radiation entering the enclosure to activate the photocatalyst inside. In this case, one or more floats comprise the photocatalyst/fiber containing structure itself. The enclosure material can comprise buoyant material, such as one or more floats, such that the photocatalyst can float and/or can be positioned in fluid being treated near the upper surface of such fluid.

In some embodiments, the photocatalyst coupled to a fiber substrate, such as quartz, glass or polymer fiber, can be enhanced by electroless or otherwise plating of a metal onto the photocatalyst in order to improve the performance of the photocatalyst in disinfection, to increase the range of light absorption, to improve the catalytic activity of the catalyst, and/or to enhance other photochemical fluid treatment processes. Exemplary photocatalysts can comprise metal chalcogenide semiconductors, including metal oxides such as titania, which exhibit good adhesion to quartz and ceramics. Electroless plating of metals onto such semiconductor coatings after the semiconductor is bonded or coupled to the fiber substrate can avoid compromising the strength of the semiconductor-fiber bond while allowing accurate control of the amount of metal added. Other methods of applying particles into the catalyst nanoparticle matrix can also be compatible with this invention, as would be apparent to those skilled in the art.

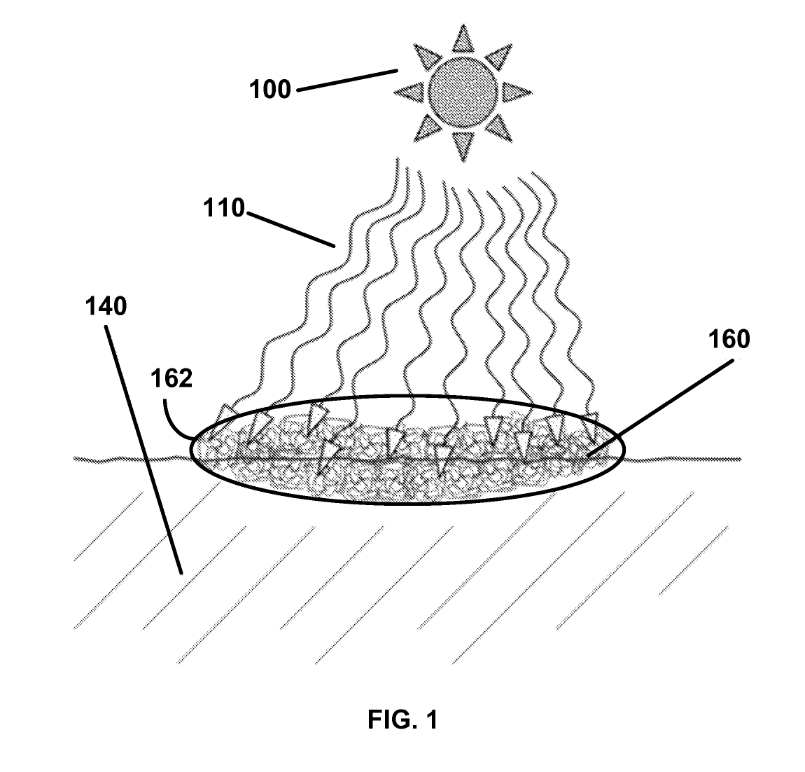

FIG. 1 is a side elevational view of an exemplary embodiment of a solar-activated photochemical treatment system in accordance with the present disclosure. Electromagnetic radiation 110 from the sun 100 illuminates at least a portion of a fluid 140 and the photocatalyst on a fiber substrate 160 in contact with the fluid. The substrate 160 can be stationary and contained in whole or in part in a liquid permeable housing 162. At least a portion of this solar radiation 110 is absorbed by at least a portion of the photocatalyst and/or directly by the contaminants in the fluid 140, inducing photochemical reactions that beneficially remove or otherwise detoxify contaminants present in the fluid. The semiconductor photocatalyst strongly absorbs a portion of solar radiation 110 with wavelengths shorter than the band gap wavelength. In some embodiments, the photocatalyst coupled to the fibers of the fiber substrate 160 can be constrained to lie at or near the surface of the fluid 140, by floating the substrate, in order to maximize coupling of solar radiation 110 to the photocatalyst

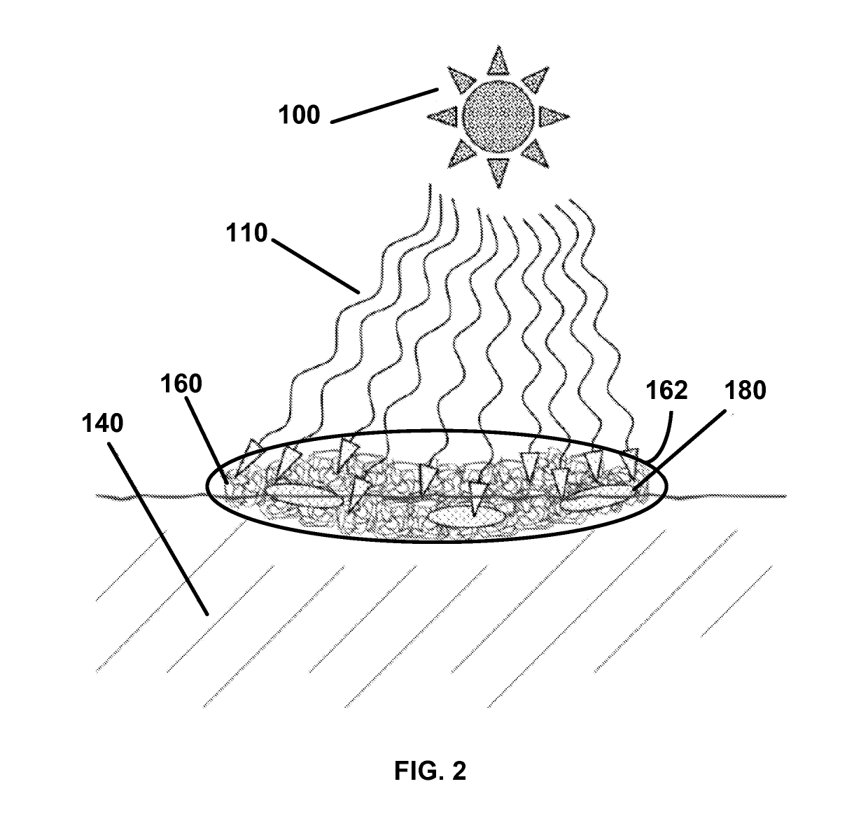

FIG. 2 is a side elevational view of another exemplary embodiment of a solar-activated photochemical treatment system in accordance with the present disclosure. Electromagnetic radiation 110 from the sun 100 illuminates at least a portion of a fluid 140 and the photocatalyst on a substrate 160 in contact with the fluid. Again, the substrate 160 can be stationary and contained in whole or in part in a liquid permeable housing 162. For example, it can be anchored or otherwise tied to the bed underneath the body of liquid being treated or by coupling one or more modules to another stationary object. At least a portion of this solar radiation 110 is absorbed by at least a portion of the photocatalyst and/or directly by the contaminants in the fluid 140, inducing photochemical reactions that beneficially remove or otherwise detoxify contaminants present in the fluid. One or more structures 180, such as floats, each having a mean density less than that of the fluid 140 can be attached within or onto the stationary fiber substrate 160 so that the fiber substrate is supported, or floats, at or near the surface of the fluid.

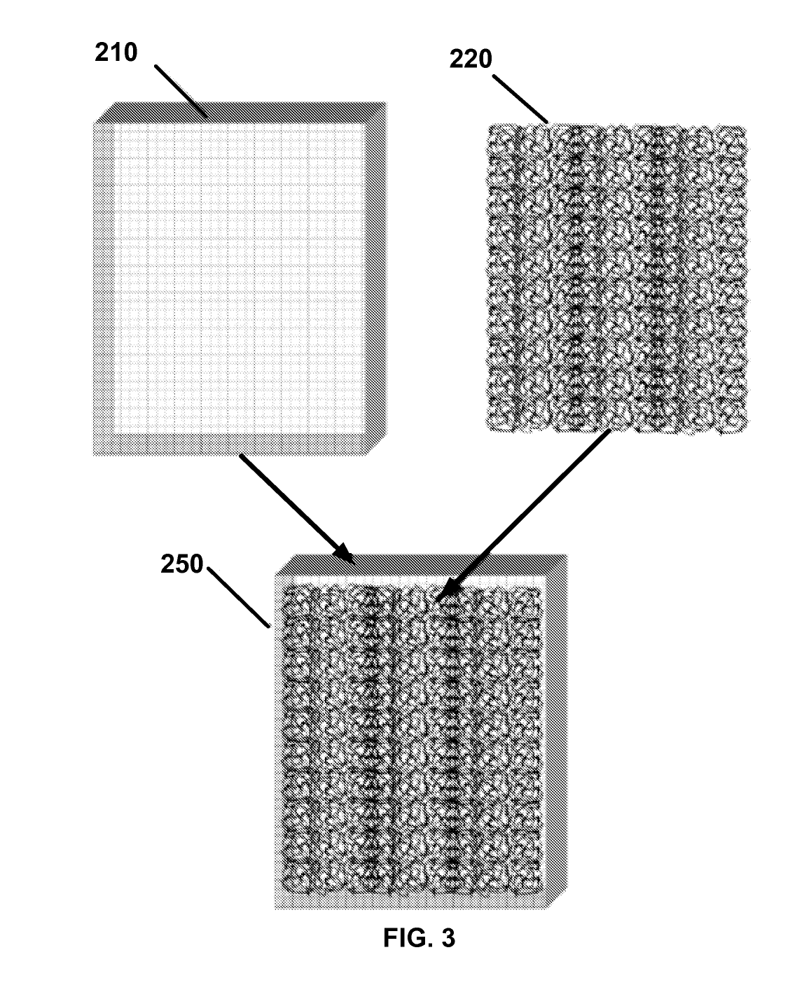

FIG. 3 illustrates schematically an exemplary photocatalyst module 250 comprising a mass of photocatalyst 220 (e.g., a fibrous substrate such as described above with photocatalyst carried thereon) captured within an enclosure, or housing, 210. The photocatalyst housing 210 can be made of a material that is porous to the fluid being treated so that the fluid can readily pass through the housing during normal operation. In addition, the housing 210 can be constructed so that sunlight can readily pass through the housing and into the photocatalyst 220. The module 250 can have an overall density less than that of the fluid, in which case the photocatalyst module can float at or near the surface of the fluid. Materials well suited for construction of this exemplary housing 210 can include woven or otherwise formed plastic fabric, webbing, mesh or other material that can be readily formed into suitable shapes and joined together or sealed (while still allowing contact by the photocatalyst with the fluid to be treated) to capture the photocatalyst material 220 within the housing 210. Sealing the housing 210 to capture the photocatalyst material 220 can be accomplished by a number of means, including ultrasonic welding and heat sealing. Another mechanism for capturing the photocatalyst material 220 within the housing 210 can comprise capturing the edges of the photocatalyst material so that the shape of the photocatalyst material is preserved by the structure of the housing and does not clump into only one portion of the housing during flow of fluid into or through the housing. Another approach for capturing the photocatalyst is to seal at least a portion of the housing material through edges of the photocatalyst and/or substrate material. In some embodiments, the housing material can be flexible, so that the housing containing the photocatalyst can be rolled or otherwise deformed without damage to the housing or photocatalyst. Still further, the housing material can comprise a substantially elastic material, so that it returns substantially to its original form when stresses causing distortions of the housing are removed. One of ordinary skill in the art will recognize that a broad range of materials and sealing technologies can be utilized for fabricating the housing.

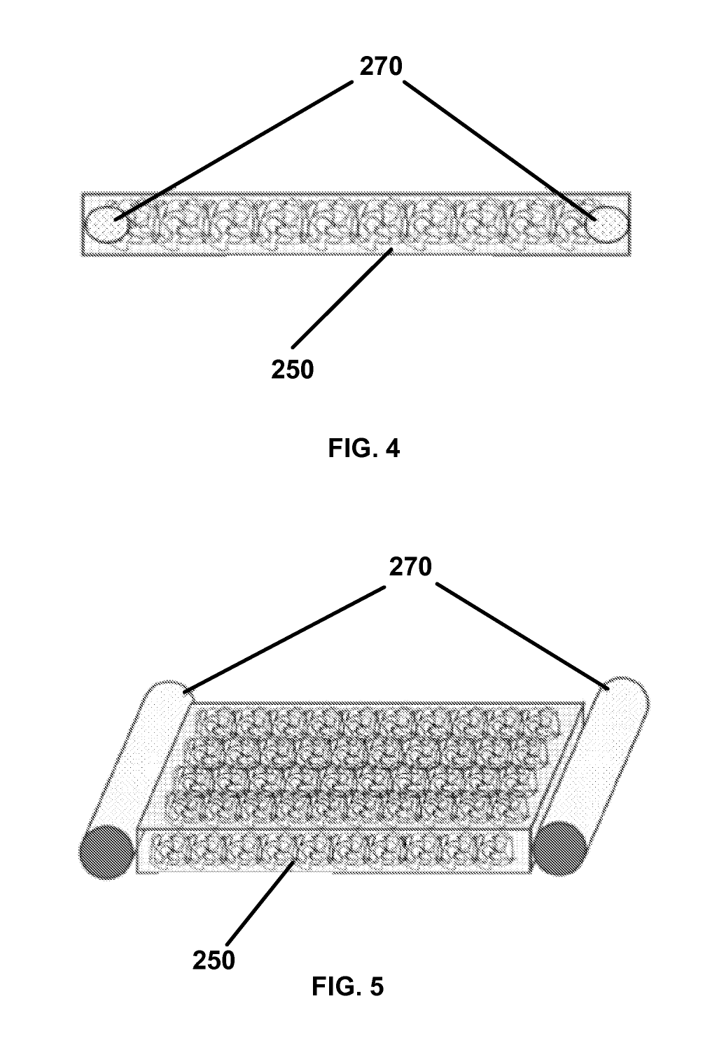

FIG. 4 is a side elevational view of an exemplary photocatalyst module 250 comprising photocatalyst coupled to a substrate within a housing. One or more structures 270, such as floats, which have a mean density less than that of the fluid to be treated, can be coupled to and/or incorporated within the housing of the module 250 so that the module can be supported, or float, at or near the surface of a fluid body being treated. Alternatively, the housing can be supported, e.g., on the bed of a shallow body of fluid, on a support and/or by tethering so as to be at or near the surface of the body of fluid.

FIG. 5 is a perspective view of another exemplary photocatalyst module 250 comprising photocatalyst coupled to a fibrous substrate within a housing, with one or more structures 270, such as floats, having mean density less than that of the fluid to be treated coupled to the housing to provide sufficient buoyancy to the photocatalyst module 250 so that it can float at or near the surface of the fluid during treatment. One skilled in the art will recognize that a broad range of materials and geometries may be utilized to providing floatation of the module 250 during fluid treatment, including floatation structures both within and exterior to the module housing.

A further exemplary embodiment in keeping with those shown in FIG. 4 and FIG. 5 can incorporate a light transmissive window on top of the photocatalyst module 250 that partially or fully covers the photocatalyst within its housing in order to protect the photocatalyst and housing from environmental contamination that might fall onto the module during operation. Suitable materials for such a window can include a broad range of polymer or other plastic materials, including sheets and films, as well as glasses and other inorganic window materials that are transmissive of the portions of the solar spectrum that contribute to photocatalytic activity within the module.

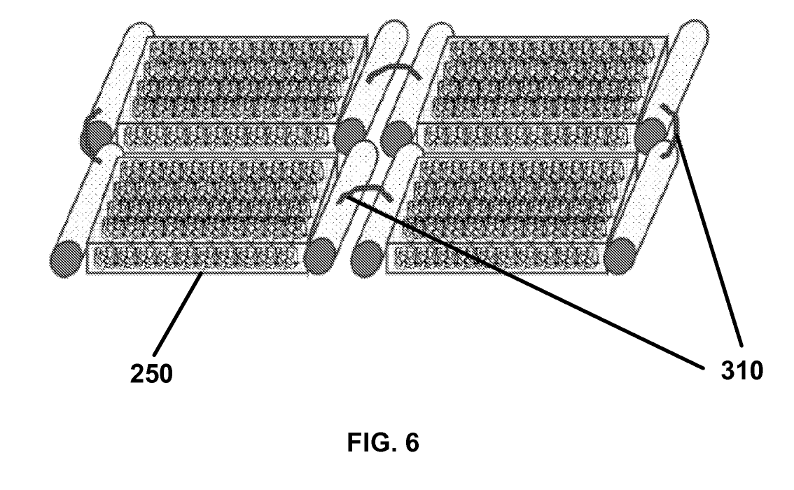

FIG. 6 shows another exemplary embodiment of a fluid treatment system, comprising a plurality of photocatalyst modules 250 coupled together by attachment mechanisms, or connectors, 310. By joining multiple photocatalyst modules 250 together, a more stable structure can be formed. Use of flexible attachments mechanisms 310 between modules 250 can help maintaining the group of interconnected modules at or near the surface of the fluid during treatment, even in the presence of turbulence or waves at the surface of the fluid. In some embodiments, the attachment mechanisms 310 can be integrated into or onto the photocatalyst modules 250. Attachment mechanisms 310 can also comprise mechanisms that are independent of the photocatalyst modules 250 that are joined together. Furthermore, the attachment mechanisms 310 can be used to couple the array of photocatalyst modules 250 to other structures within the fluid, such as, for example, to stabilize the location of the array of photocatalyst modules within or on the surface of the fluid. Exemplary attachment mechanisms can include cables, wires, ropes, snaps, hooks, etc. One skilled in the art will recognize that a broad range of joining mechanisms may be used for this purpose.

The group of modules 250 can be arrayed in a spaced array and can have equal spacing between the modules. Alternatively, the group can be irregularly spaced apart. One or more individual modules 250 can be anchored to retain the group of modules at a desired location for liquid treatment. This disclosure also encompasses individual modules 250 comprising one or more floats, a fiber substrate contained at least partially within a liquid permeable housing, and at least one semiconductor catalyst coupled to the fibers of the fiber substrate. Groups of such individual modules 250 interconnected into a raft of plural modules are also encompassed by this disclosure. In addition, not all of the modules in a group of modules need to float individually, as a common floatation structure can be used to cause the group to float. The common floatation structure can comprise one or more of the modules in the group of modules.

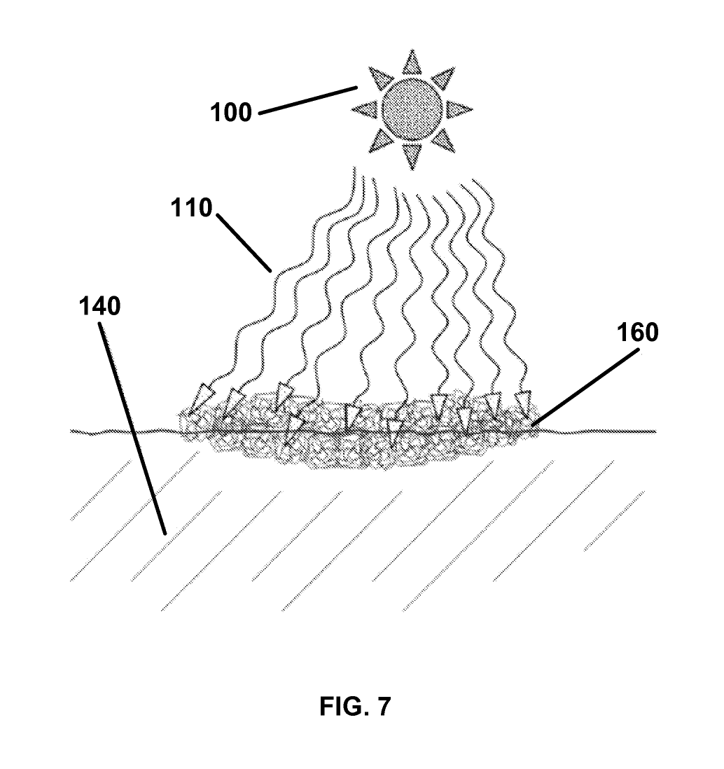

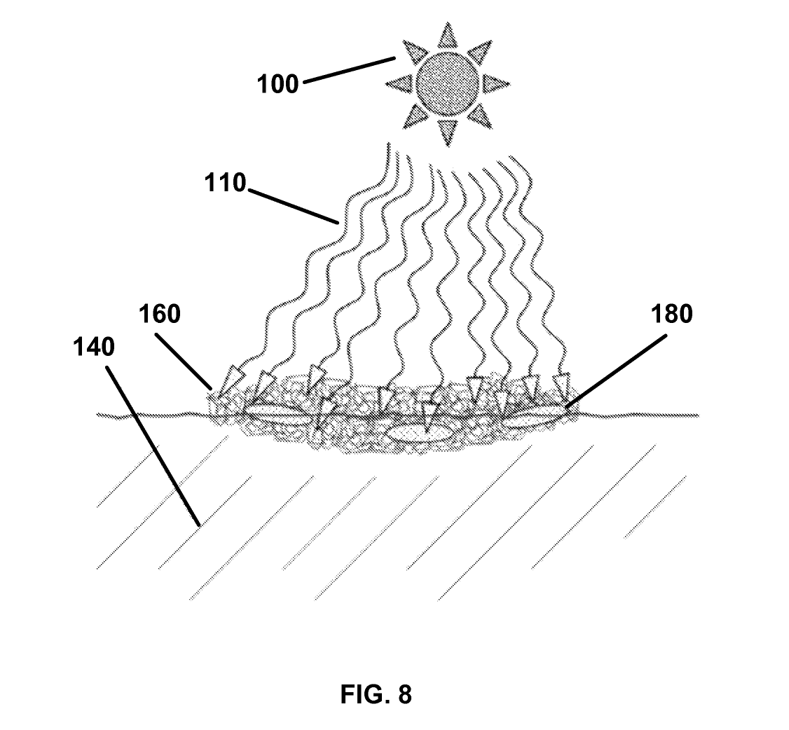

In some embodiments, such as those shown in FIGS. 7 and 8, a solar-activated photochemical fluid treatment system can comprise a porous and/or fibrous substrate and a semiconductor photocatalyst coupled to the substrate, without an additional housing enclosing the substrate. Some such embodiments can comprise floats coupled to the substrate, as shown in FIG. 8. Other embodiments do not comprise discrete and/or integrated floats, as shown in FIG. 7, but can still be supported in a body of fluid to be treated. In these embodiments, the substrate can have sufficient structural integrity to maintain its shape and function without the constraints of an external housing. Furthermore, a plurality of such treatment devices can be coupled together to form a floating group, or raft, or flotilla, with or without additional floats coupled thereto.

With reference to FIGS. 7 and 8, electromagnetic radiation 110 from the sun 100 illuminates at least a portion of a fluid 140 and the photocatalyst on a fiber substrate 160 in contact with the fluid. At least a portion of this solar radiation 110 is absorbed by at least a portion of the photocatalyst and/or directly by the contaminants in the fluid 140, inducing photochemical reactions that beneficially remove or otherwise detoxify contaminants present in the fluid. The semiconductor photocatalyst strongly absorbs a portion of solar radiation 110 with wavelengths shorter than the band gap wavelength. In some embodiments, the photocatalyst coupled to the fibers of the fiber substrate 160 can be constrained to lie at or near the surface of the fluid 140, by floating the substrate, in order to maximize coupling of solar radiation 110 to the photocatalyst. One or more structures 180, such as floats, each having a mean density less than that of the fluid 140 can be attached within or onto the stationary fiber substrate 160 so that the fiber substrate is supported, or floats, at or near the surface of the fluid.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

1. A solar-activated photochemical fluid treatment system comprising:
at least one module comprising an at least partially sunlight-transmissive porous fiber substrate and a semiconductor photocatalyst coupled to the fiber substrate, the module being configured to allow liquid and sunlight to be in contact with the semiconductor photocatalyst; and
one or more floats coupled to the at least one module such that the at least one module floats at or near a surface of an open body of liquid, such that, responsive to solar radiation being applied to the semiconductor photocatalyst, photochemical modification of contaminants and living organisms in the liquid occurs.

2. The system of claim 1, wherein the at least one module further comprises a liquid permeable housing, the substrate is contained in whole or in part within the housing, and the housing comprises a polymeric mesh.

3. The system of claim 2, wherein the mesh is at least partially sunlight transmissive.

4. The system of claim 1, wherein the system comprises first and second floats, the at least one module having first and second opposing ends, the first float being coupled to the first end of the module and the second float being coupled to the second end of the module.

5. The system of claim 1, wherein the specific surface area of the photocatalyst within at least one portion of the fluid is greater than 100 square meters per liter of the fluid.

6. The system of claim 1, wherein the at least one module further comprises a metal deposited onto the photocatalyst by an electroless process.

7. (canceled)

8. A solar-activated photochemical fluid treatment system comprising:
a plurality of modules, each module comprising an at least partially sunlight-transmissive porous substrate and a semiconductor photocatalyst coupled to the substrate, the modules being configured to allow liquid and sunlight to be in contact with the semiconductor photocatalyst, wherein the specific surface area of the photocatalyst within at least one portion of the liquid is greater than 100 square meters per liter of the liquid;
one or more connectors coupling the plurality of modules together to form a group of interconnected modules; and
one or more floats coupled to the group of modules such that the group of modules floats in a body of liquid such that, responsive to solar radiation being applied to the semiconductor photocatalyst, photochemical modification of contaminants and living organisms in the liquid occurs.

9. The system of claim 8, wherein the group of modules has an overall density of less than or equal to a density of the liquid, such that the group of modules floats or rises toward an upper surface of the body of liquid.

10. The system of claim 8, wherein each of the plurality of modules further comprises a liquid permeable housing, the substrate is contained in whole or in part within the housing, and the housing comprises a polymeric mesh.

11. The system of claim 10, wherein the mesh is at least partially sunlight transmissive.

12. (canceled)

13. The system of claim 8, wherein one or more floats is coupled to each module of the group of modules.

14. (canceled)

15. The system of claim 8, wherein one or more of the modules further comprises a metal deposited onto the photocatalyst by an electroless process.

16. The system of claim 8, wherein the substrate is a fiber substrate.

17. A method for purifying a fluid, the method comprising:
placing a module into a body of liquid exposed to solar radiation, the module comprising an at least partially sunlight-transmissive porous fiber substrate and a semiconductor photocatalyst coupled to the fiber substrate, the module being configured to allow liquid and sunlight to pass into contact with the semiconductor photocatalyst, the module further comprising one or more floats coupled to the substrate such that the module floats at or near an upper surface of the body of liquid such that, responsive to solar radiation applied to the semiconductor photocatalyst, photochemical modification of contaminants and living organisms in the liquid occurs.

18. (canceled)

19. The method of claim 17, wherein the module further comprises a liquid permeable housing, the substrate is contained in whole or in part within the housing, and the housing comprises a polymeric mesh.

20. The method of claim 19, wherein the mesh is at least partially sunlight transmissive.

21. (canceled)

22. The method of claim 17, wherein the specific surface area of the photocatalyst within at least one portion of the fluid is greater than 100 square meters per liter of the fluid.

23. (canceled)

24. A method for purifying a fluid, the method comprising:
placing a group of interconnected modules into a body of liquid exposed to solar radiation, the group of modules being coupled together with one or more connectors, each module comprising an at least partially sunlight-transmissive porous fiber substrate and a semiconductor photocatalyst coupled to the fiber substrate, the module being configured to allow liquid and sunlight to pass into contact with the semiconductor photocatalyst, the group of modules further comprising one or more floats such that the group of modules floats at or near an upper surface of the body of liquid such that, responsive to solar radiation incident upon the semiconductor photocatalyst, photochemical modification of contaminants and living organisms in the liquid occurs.

25. The method of claim 24, wherein the photocatalyst was modified after it was coupled to the substrate.

26. The method of claim 24, wherein one or more of the modules further comprises a metal deposited onto the photocatalyst by an electroless process.

27. The method of claim 24, wherein one or more of the modules further comprises a liquid permeable housing, the substrate is contained in whole or in part within the housing, and the housing comprises a polymeric mesh.

28. The method of claim 27, wherein the mesh is at least partially sunlight transmissive.

29. (canceled)

30. The method of claim 24, wherein one or more floats is coupled to each module of the group of modules.

31. The method of claim 24, wherein the specific surface area of the photocatalyst within at least one portion of the fluid is greater than 100 square meters per liter of the fluid.

32. (canceled)

33. The system of claim 1, wherein the at least one module has an overall density of less than or equal to a density of the liquid, such that the at least one module floats or rises toward an upper surface of the body of liquid.
